(19) United States
(12) Patent Application Publication
(10) Pub. No.: US 2026/0070734 A1
(43) Pub. Date: Mar. 12, 2026

(54) METHOD FOR CONTROLLING CARGO LOADING AND UNLOADING APPARATUS TO PULL CARGO AWAY FROM SHELVING RACK

(71) Applicant: Libiao Robotics Holdings Pte. Ltd., Singapore (SG)

(72) Inventor: Jianqiang ZHU, Zhejiang (CN)

(21) Appl. No.: 19/128,359

(22) PCT Filed: Jun. 27, 2023
(86) PCT No.: PCT/CN2023/102873

§ 371 Date: May 8, 2025

(30) Foreign Application Priority Data
Nov. 10, 2022 (CN) 202211407951.1

(51) Int. Cl. B65G 1/04; B66F 9/075

(52) U.S. Cl. CPC B65G 1/0435; B66F 9/0755; B65G 2203/041; B65G 2203/042

(57) ABSTRACT

Method for controlling cargo handling apparatus to pull cargo away from shelving rack includes: box pulling machine moving to exit/entrance where pre-determined cargo box in shelving rack is located, and manipulator at box pulling machine moving towards box; ranging device starting ranging, and when distance reaches pre-determined value, finger of manipulator being hooked onto handle at outer end of cargo box from bottom to top and dragging cargo box to move outwards, and ranging device monitoring distance; if distance is maintained within a pre-determined range, finger dragging cargo box to preset position of box pulling machine cargo platform, and being separated from handle to complete pulling cargo box; and if distance exceeds pre-determined range to cause unhooking, platform moving downwards to be lower than shelving rack shelf, outer end of cargo box moving downwards under action of its weight, finger moving towards cargo box again, and repeating step S2.

### CROSS-REFERENCE TO RELATED APPLICATION

The present disclosure claims the priority to the Chinese patent application No. 202211407951.1 filed on Nov. 10, 2022 and entitled “METHOD FOR CONTROLLING GOODS HANDLING EQUIPMENT TO PULL GOODS AWAY FROM RACK”, the contents of which are incorporated herein by reference in entirety.

### TECHNICAL FIELD

The present disclosure relates to a goods handling equipment (automated storage and retrieval equipment) on a rack.

### BACKGROUND ART

The rack is configured to store goods and is characterized by large capacity, small occupation, convenient loading and unloading, and low cost. To enhance the automation level of loading and unloading, independent rack handling equipment is usually configured. A Chinese patent with application number CN202111124857.0, entitled “GOODS HANDLING EQUIPMENT FIXED ON RACK” discloses a goods handling equipment that is directly mounted on the rack and can automatically complete the loading and unloading of goods. However, in practical application, the following issues still exist: when the position of the goods stored in the bin deviates from the center of the bin, the weight-shifted goods can cause the bin to tilt under the influence of the self-weight of the goods, thereby causing the bin to disengage from the bin-pulling hook of the bin-pulling machine in the rack handling equipment, so that the bin cannot be transported to the loading platform of the bin-pulling machine.

### SUMMARY

A method for controlling goods handling equipment to pull goods away from rack is provided in the present disclosure, which can at least prevent a manipulator from unhooking a bin.

A method for controlling goods handling equipment to pull goods away from rack provided by the present disclosure, includes a goods handling equipment body, and when the goods handling equipment body pulls goods away from the rack, the following control steps are performed.

S1. The controller of the goods handling equipment receives an instruction from a server, and according to the instruction, the bin-pulling machine (autonomous bin-handling robot) in the goods handling equipment body moves to the entrance and exit of the predetermined bin on the rack, and the manipulator on the bin-pulling machine moves towards the predetermined bin.

S2. The distance measuring device on the bin-pulling machine starts to measure the distance between the manipulator and the bin, and when the distance between the manipulator and the bin reaches a predetermined value, the finger of the manipulator hooks the handle at the outer end of the bin from bottom to top, and lift the handle of the bin up to make the bottom outer end of the bin higher than the loading platform.

S3. The finger of the manipulator drags the bin to move outwards, and at the same time, the distance measuring device monitors the distance between the manipulator and the bin, or the distance is monitored through an unhooking sensor mounted on the manipulator. The unhooking sensor is electrically connected with the controller.

S4. If the distance between the finger of the manipulator and the bin is maintained within a predetermined normal range, the finger of the manipulator drags the bin to a predetermined position on the loading platform of the bin-pulling machine, and the finger of the manipulator disengages from the handle at the outer end of the bin to complete the pulling of the bin.

S5. If the distance between the finger of the manipulator and the bin exceeds the predetermined normal range, it is determined to be an unhooking state.

S6. In this case, the loading platform of the bin-pulling machine moves downwards to be lower than the partition plate of the rack, the outer end of the bin moves downwards under the action of self-weight, the finger of the manipulator moves towards the bin again, and step S2 is repeated until the finger of the manipulator drags the bin to the predetermined position of the loading platform of the bin-pulling machine. The finger of the manipulator disengages from the handles at the outer end of the bin to complete the pulling of the bin.

As an exemplary example, in step S1, the height of the loading platform of the bin-pulling machine can be equal to or higher than the height of the partition plate of the rack.

As an exemplary example, when the bin is pulled, the outer end of the bin can be lifted upward, the bin is pulled out obliquely, and the bottom of the bin will touch the loading platform.

As an exemplary example, the distance measuring device can be a laser range finder or an ultrasonic range finder, and the laser range finder or ultrasonic range finder is fixed on the manipulator and electrically connected with the controller of the goods handling equipment.

As an exemplary example, the distance measuring device can be a reset switch, and the reset switch is fixed on the finger of the manipulator. When the finger of the manipulator touches the bin, the reset switch acts. The reset switch is electrically connected with the controller of the goods handling equipment.

As an exemplary example, the distance measuring device can be a ranging camera, which is fixed on the manipulator and electrically connected with the controller of the goods handling equipment. The controller judges the distance between the finger of the manipulator and the bin according to the image information of the finger of the manipulator and the bin handle collected by the ranging camera.

As an exemplary example, in step S2, the finger of the manipulator can be rotated to a horizontal position from bottom to top, and the goods handling equipment controls the bin-pulling machine to move up, so that the handle of the bin is lifted up, making the bin oblique.

As an exemplary example, in step S5, when the unhooking state occurs, the controller of the goods handling equipment and/or the bin-pulling machine gives an alarm signal, wherein the alarm signal includes an audible and visual alarm signal.

As an exemplary example, the distance measuring device can be fixed on the manipulator, and when the finger needs to pull the bin, the distance measuring device is directly facing the bin.

As an exemplary example, the distance measuring device can be fixed on the arm of the manipulator and can rotate with the arm. When two rows of racks are provided and placed in parallel, the distance measuring device can aim at any bin in the two rows of racks, and the bin can be pulled by the manipulator.

As an exemplary example, in step S1, the manipulator on the bin-pulling machine is rotated from being far away from the bin to be pulled to facing the bin, so that the distance measuring device can be conveniently aimed at the bin.

As an exemplary example, when the arm of the manipulator rotates at least plus 90 degrees or minus 90 degrees, the manipulator is being far away from the bin.

Compared with related technologies, the present disclosure has at least the following advantages.

The speed of the bin-pulling can be accelerated. When the goods stored in the bin deviates from the center position, in case of unhooking when pulling the bin, the situation can be found in time and the bin can be pulled again in time.

The present disclosure at least has the beneficial effects of low hardware cost, preventing unhooking during the pulling of a bin, and fast goods-pulling speed.

### BRIEF DESCRIPTION OF THE DRAWINGS

FIG. 1 is a schematic diagram of an overall simplified structure of a goods handling equipment body mounted on a rack according to the present disclosure.

FIG. 2 is a schematic structural diagram of a goods handling equipment body according to an example of the present disclosure.

FIG. 3 is a side view of a bin-pulling machine.

FIG. 4 is a schematic structural diagram of a bin-pulling machine about to hook a bin according to the present disclosure.

FIG. 5 is a schematic structural diagram of the finger of a bin-pulling machine lifting up a bin according to the present disclosure.

FIG. 6 is a schematic structural diagram of a finger unhooking from a bin according to the present disclosure.

FIG. 7 is a schematic structural diagram of hooking a bin again after a finger is unhooked according to the present disclosure.

FIG. 8 is a schematic diagram of a three-dimensional structure of a bin-pulling machine according to the present disclosure.

### DETAILED DESCRIPTION OF EMBODIMENTS

The present disclosure is further described in conjunction with the accompanying drawings.

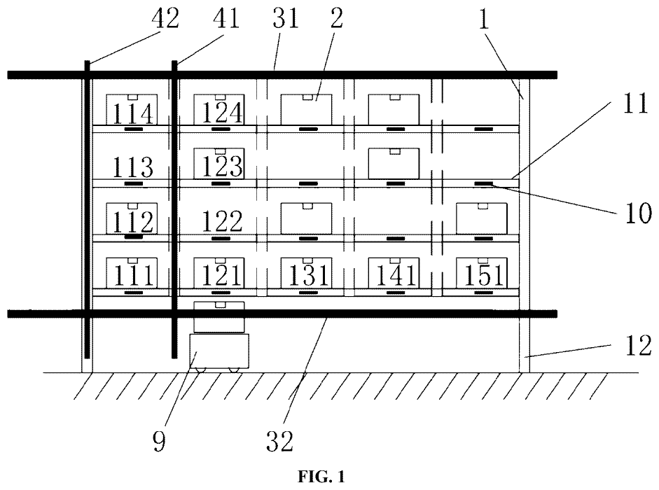

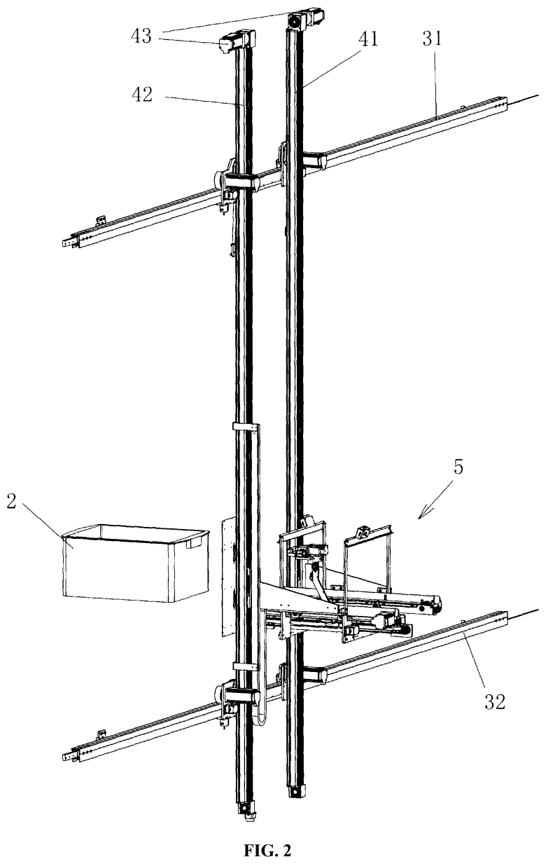

As shown in figures, a method for controlling goods handling equipment to pull goods away from a rack includes a goods handling equipment body, as shown in FIG. 1 and FIG. 2. When the goods handling equipment body pulls goods away from the rack, the following control steps are performed.

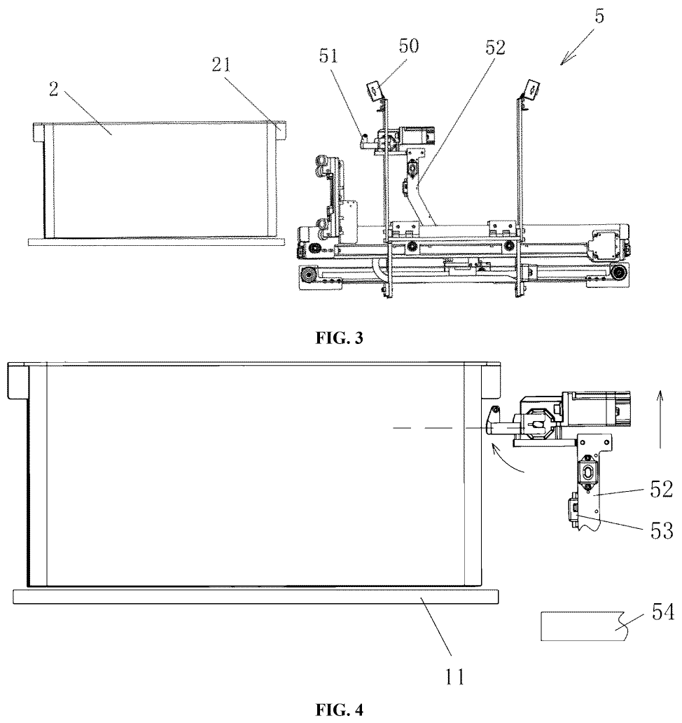

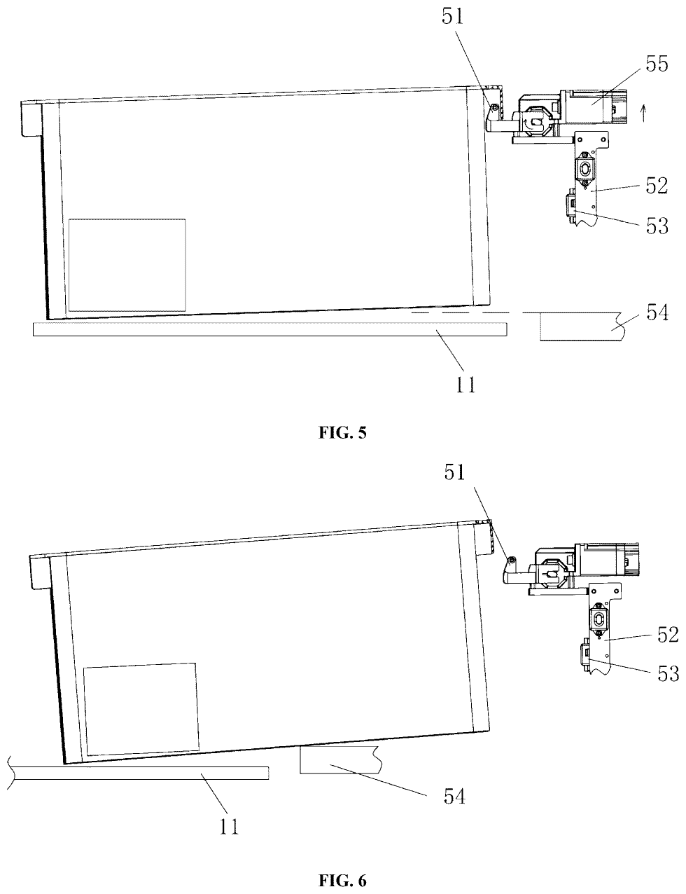

S1. The controller of the goods handling equipment receives an instruction from a server, and according to the instruction, the bin-pulling machine 5 in the goods handling equipment body moves to the entrance and exit of the predetermined bin 2 on the rack 1, as shown in FIG. 3. In step S1, optionally, the height of the loading platform 54 of the bin-pulling machine 5 is equal to or higher than the height of the partition plate 11 of the rack 1. Since it is more difficult to control the two at the same height, the height of the loading platform 54 of the bin-pulling machine 5 is usually chosen to be higher than the height of the partition plate 11 of the rack 1. The manipulator on the bin-pulling machine 5 moves towards the predetermined bin 2, as shown in FIG. 4 and FIG. 5.

S2. At the same time, the distance measuring device on the bin-pulling machine 5 starts to measure the distance between the manipulator and the bin 2, when the distance between the manipulator and the bin 2 reaches a predetermined value, the finger 51 of the manipulator rotates from bottom to top, that is, rotates clockwise, as shown in FIG. 4, to hook the handle 21 at the outer end of the bin 2, and lift the handle 21 of the bin 2 up to make the bottom outer end of the bin 2 higher than the loading platform 54, as shown in FIG. 5. It should be noted that when the outer end of the bin 2 is raised, the resistance to pulling the bin can be reduced.

S3. The finger 51 of the manipulator drags the bin 2 to move outwards, and at the same time, the distance measuring device monitors the distance between the manipulator and the bin 2, or the distance is monitored through an unhooking sensor mounted on the manipulator, and the unhooking sensor is electrically connected with the controller.

S4. If the distance between the finger 51 of the manipulator and the bin 2 is maintained within a predetermined normal range, the finger 51 of the manipulator drags the bin 2 to a predetermined position on the loading platform of the bin-pulling machine 5, and the finger 51 of the manipulator rotates clockwise for 45-90 degrees, and the finger 51 of the manipulator disengages from the handle 21 at the outer end of the bin 2 to complete the pulling of the bin 2.

S5. If the distance between the finger 51 of the manipulator and the bin 2 exceeds the predetermined normal range, it is determined to be in the unhooking state. Usually, the goods in the bin 2 are placed deviating from the center position of the bin 2, as shown in FIG. 5 and FIG. 6.

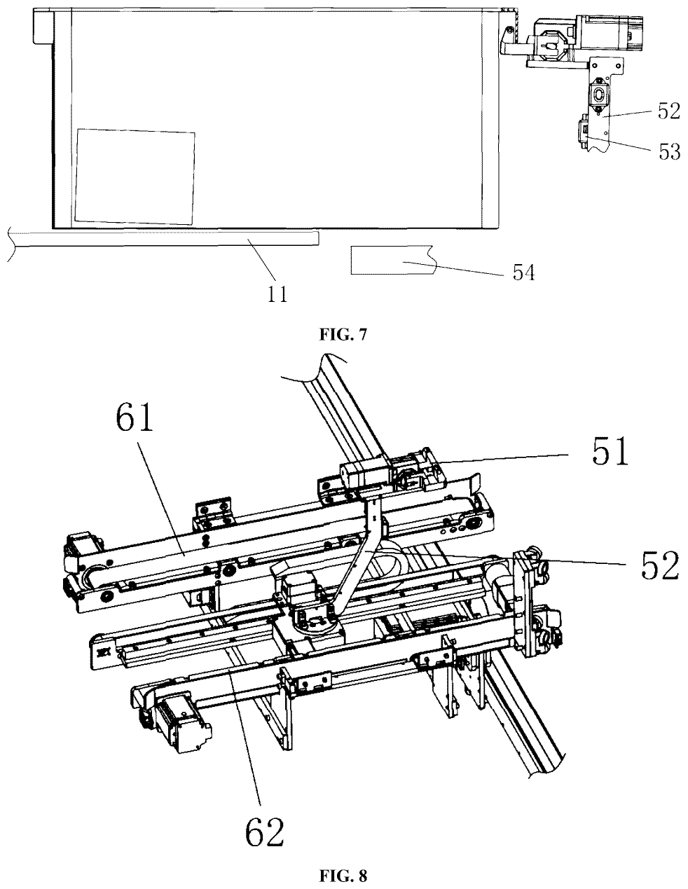

S6. In this case, the loading platform 54 of the bin-pulling machine 5 moves downwards to be lower than the partition plate 11 of the rack 1, as shown in FIG. 7. The outer end of the bin 2 moves downwards under the action of self-weight, the finger 51 of the manipulator moves towards the bin 2 again, and step S2 is repeated until the finger 51 of the manipulator drags the bin 2 to the predetermined position of the loading platform of the bin-pulling machine 5. The finger 51 of the manipulator disengages from the handles 21 at the outer end of the bin 2 to complete the pulling of the bin 2.

It should be noted that the goods handling equipment body of the present disclosure has the functions of taking out the bin 2 from the rack 1 and storing the bin 2 in the rack 1. The bin-pulling machine 5 in the goods handling equipment body can move up and down, left and right to the predetermined bin 2. The goods handling equipment body includes the equipment provided in the Chinese patent with application number CN202111124857.0, entitled “GOODS HANDLING EQUIPMENT FIXED ON RACK”, as shown in FIG. 1, FIG. 2 and FIG. 3.

In the figures, the upper guide rail 31 and the lower guide rail 32 are provided, which are respectively fixed at the upper and lower parts of the rack 1. A plurality of bins 2 can be stored in the rack 1, and the goods can be stored in the bins 2. Each bin 2 has an address such as 111 and 112, and a two-dimensional code or bar code 10 is pasted on the partition plate 11 of the rack 1. The camera 50 on the bin-pulling machine 5 recognizes the two-dimensional code or bar code 10 and locates the bin-pulling machine 5.

A first upper roller and a second upper roller driven by an upper motor are respectively mounted at the upper parts of the first upright 41 and the second upright 42, and a first lower roller and a second lower roller driven by a lower motor are respectively mounted at the lower parts of the first upright 41 and the second upright 42. The first upper roller and the second upper roller can roll on the upper guide rail 31, and the first lower roller and the second lower roller can roll on the lower guide rail 32.

A first vertical slider and a second vertical slider driven by a first vertical moving driving device and a second vertical moving driving device are respectively mounted on the first upright 41 and the second upright 42, and the first vertical slider and the second vertical slider are hinged with the loading-unloading machine frame of the bin-pulling machine 5, also known as the loading and unloading device. The loading-unloading machine frame can move up and down along the first upright 41 and the second upright 42.

The loading-unloading machine frame is further provided with a first conveyor belt 61 and a second conveyor belt 62 driven by a conveyor motor as a loading platform. The bin 2 can be dragged onto the first conveyor belt 61 and the second conveyor belt 62, and then the bin 2 is transported to the central position of the loading-unloading machine frame by the first conveyor belt 61 and the second conveyor belt 62. The manipulator is mounted on the loading-unloading machine frame through a slide rail and driven by a dragging motor. The arm 52 of the manipulator can rotate, and the finger 51 of the manipulator can also rotate, as shown in FIG. 8.

The goods handling equipment body can further choose a robot walking on the ground, and the robot is equipped with a bin-pulling machine 5. Obviously, the first upright 41 and the second upright 42 shown in FIG. 2 can be directly fixed on the robot. By replacing the upper guide rail 31, the lower guide rail 32 and the rollers with a robot, the robot can travel directly on the ground.

It should also be noted that when the bin 2 is pulled, the outer end of the bin 2 is lifted upward, and when the bin 2 is pulled out obliquely, the bottom of the bin 2 will touch the loading platform 54, as shown in FIG. 6, so that the bin 2 can be smoothly dragged onto the loading platform 54. Assuming that the loading platform 54 is lower than the partition plate of the rack 1, a step will occur, so that vibration will be generated when the bin 2 falls from the partition plate 11 of the rack to the loading platform 54, some fragile goods will be easy to damage, which is not the preferred solution.

As an exemplary example, the distance measuring device is a laser range finder 53 or an ultrasonic range finder, as shown in FIG. 3 and FIG. 4. The laser range finder 53 or ultrasonic range finder is fixed on the manipulator and electrically connected with the controller of the goods handling equipment.

As another example, the distance measuring device is a reset switch, and the reset switch is fixed on the finger 51 of the manipulator. When the finger 51 of the manipulator touches the bin 2, the reset switch acts. The reset switch is electrically connected with the controller of the goods handling equipment, and the unhooking sensor and the reset switch can be used simultaneously.

As another example, the distance measuring device is a ranging camera, which is fixed on the manipulator, usually at a position higher than the finger 51 on the loading-unloading machine frame through the machine frame. The ranging camera is electrically connected with the controller of the goods handling equipment. The controller judges the distance between the finger 51 of the manipulator and the bin 2 according to the image information of the finger 51 of the manipulator and the handle 21 of the bin 2 collected by the ranging camera. It should be noted that the image information of the finger 51 of the manipulator pulling the handle 21 of the bin 2 is taken as the reference standard, and in the actual operation process, it is normal when the information collected by the ranging camera meets the reference standard; otherwise, it can be regarded as being abnormal and can be identified by software.

As an exemplary example, in step S2, the finger 51 of the manipulator rotates to a horizontal position from bottom to top by its own rotation, as shown in FIG. 4, where the dotted line in the FIG. 4 represents the horizontal position, and the goods handling equipment controls the bin-pulling machine 5 to move up vertically. As shown in FIG. 5, the handle 21 of the bin 2 is raised, making the bin 2 oblique.

It is to be noted that the rotation of the finger 51 of the manipulator can be controlled by the grasping motor 55, as shown in FIG. 5. The vertically upward movement of the bin-pulling machine 5 can be driven by the vertical movement driving motor 43 in the vertical movement driving device via a synchronous belt to drive the bin-pulling machine 5 to move up and down vertically along the first upright 41 and the second upright 42 of the slide rail structure, as shown in FIG. 2.

As an exemplary example, in step S5, when the unhooking state occurs, the controller of the goods handling equipment and/or the bin-pulling machine 5 gives an alarm signal, wherein the alarm signal includes an audible and visual alarm signal, thereby the unhooking equipment can be found in time in large-scale rack warehouses.

As an exemplary example, the distance measuring device is fixed on the manipulator, and when the finger 51 needs to pull the bin, the distance measuring device is directly facing the bin 2, as shown in FIG. 3, FIG. 4 and FIG. 5. Generally, the distance measuring device is fixed on the arm 52 of the manipulator and can rotate with the arm 52, as shown in FIG. 8.

As an exemplary example, when two rows of racks are provided and placed in a parallel way, the distance measuring device can aim at any bin 2 in the two rows of racks, and the bin 2 can be pulled by the manipulator.

As an exemplary example, in step S1, the manipulator on the bin-pulling machine 5 is rotated from being far away from the bin 2 to be pulled to facing the bin 2, so that the distance measuring device can be conveniently aimed at the bin 2. In FIG. 8, the distance measuring device aims at the bin 2; in the figure, when the arm 52 of the manipulator rotates at least plus 90 degrees or minus 90 degrees, the manipulator is being far away from the bin 2.

In the present disclosure, when loading and unloading goods, the ground robot 9 transports the bin 2 to the bottom of the rack 1, and the bin-pulling machine 5 moves to the bottom to pull out the bin 2 delivered by the ground robot. The bin-pulling machine 5 then transports the bin 2 to the entrance and exit of the predetermined rack vacancy above the bottom, and pushes the bin 2 into the rack vacancy. The process of taking the bin 2 from the rack 1 and delivering the bin 2 to the ground robot 9 is just the opposite. The principles of pulling the bin and pushing the bin are basically the same.

### INDUSTRIAL PRACTICABILITY

A method for controlling goods handling equipment to pull goods away from rack is provided in the present disclosure, wherein the following steps are performed: S1, the bin-pulling machine in the goods handling equipment body moves to the entrance and exit of the predetermined bin on the rack, and the manipulator on the bin-pulling machine moves towards the predetermined bin; S2, a distance measuring device starts to measure the distance, and when the distance reaches a predetermined value, the finger of the manipulator hooks the handle at the outer end of the bin from bottom to top; S3, the finger of manipulator drags the bin to move outward, and the distance measuring device monitors the distance; S4, when the distance is maintained within a predetermined range, the finger of the manipulator drags the bin to a predetermined position on the loading platform of the bin-pulling machine, and the finger of the manipulator disengages from the handle at the outer end of the bin to complete the pulling of the bin; S5, if the distance exceeds the predetermined range, resulting in unhooking, S6, the loading platform of the bin-pulling machine moves downwards to be lower than the partition plate of the rack, the outer end of the bin moves downwards under the action of self-weight, the finger of the manipulator moves towards the bin again, and step S2 is repeated. The present disclosure has the beneficial effect of preventing unhooking during the pulling of the bin.

In addition, it can be understood that the method for controlling goods handling equipment to pull goods away from the rack of the present disclosure is reproducible and can be utilized in various industrial applications. For example, the method for controlling goods handling equipment to pull goods away from the rack of the present disclosure can be used in the technical field of goods handling equipment.

1. A method for controlling goods handling equipment to pull goods away from rack, comprising a goods handling equipment body, wherein when the goods handling equipment body pulls the goods away from the rack, following control steps are performed:
S1, a controller of the goods handling equipment receives an instruction from a server, and according to the instruction, a bin-pulling machine in the goods handling equipment body moves to an entrance and exit of a predetermined bin on the rack and a manipulator on the bin-pulling machine moves towards the predetermined bin meanwhile,
S2, a distance measuring device on the bin-pulling machine starts to measure a distance between the manipulator and the bin when the distance between the manipulator and the bin reaches a predetermined value, a finger of the manipulator hooks a handle at an outer end of the bin from bottom to top, and lifts the handle of the bin up to make a bottom outer end of the bin higher than a loading platform;
S3, the finger of the manipulator drags the bin to move outwards, and at the same time, the distance measuring device monitors the distance between the manipulator and the bin or the distance is monitored through an unhooking sensor mounted on the manipulator, wherein the unhooking sensor is electrically connected with the controller;
S4, when the distance between the finger of the manipulator and the bin is maintained within a predetermined normal range, the finger of the manipulator drags the bin to a predetermined position on the loading platform of the bin-pulling machine and the finger of the manipulator disengages from the handle at the outer end of the bin to complete a pulling of the bin;
S5, when the distance between the finger of the manipulator and the bin exceeds the predetermined normal range, it is determined to be an unhooking state; and in this case,
S6, the loading platform of the bin-pulling machine moves downwards to be lower than a partition plate of the rack the outer end of the bin moves downwards under an action of self-weight, the finger of the manipulator moves towards the bin again, and step S2 is repeated until the finger of the manipulator drags the bin to the predetermined position of the loading platform of the bin-pulling machine and the finger of the manipulator disengages from the handle at the outer end of the bin to complete the pulling of the bin.

2. The method for controlling goods handling equipment to pull goods away from rack according to claim 1, wherein in step S1, a height of the loading platform of the bin-pulling machine is equal to or higher than a height of the partition plate of the rack.

3. The method for controlling goods handling equipment to pull goods away from rack according to claim 1 wherein when the bin is pulled, the outer end of the bin is lifted upward, the bin is pulled out obliquely, and a bottom of the bin touches the loading platform.

4. The method for controlling goods handling equipment to pull goods away from rack according to claim 2, wherein the distance measuring device is a laser range finder or an ultrasonic range finder, and the laser range finder or ultrasonic range finder is fixed on the manipulator and electrically connected with the controller of the goods handling equipment.

5. The method for controlling goods handling equipment to pull goods away from rack according to claim 2, wherein the distance measuring device is a reset switch, and the reset switch is fixed on the finger of the manipulator; when the finger of the manipulator touches the bin the reset switch acts; and the reset switch is electrically connected with the controller of the goods handling equipment.

6. The method for controlling goods handling equipment to pull goods away from rack according to claim 2, wherein the distance measuring device is a ranging camera, wherein the ranging camera is fixed on the manipulator and electrically connected with the controller of the goods handling equipment; the controller judges the distance between the finger of the manipulator and the bin according to an image information of the finger of the manipulator and the handle of the bin collected by the ranging camera.

7. The method for controlling goods handling equipment to pull goods away from rack according to claim 1, wherein in step S2, the finger of the manipulator rotates to a horizontal position from bottom to top, and the goods handling equipment controls the bin-pulling machine to move up, so that the handle of the bin is lifted up, making the bin oblique.

8. The method for controlling goods handling equipment to pull goods away from rack according to claim 1, wherein in step S5, when the unhooking state occurs, the controller of the goods handling equipment and/or the bin-pulling machine gives an alarm signal, and the alarm signal comprises an audible and visual alarm signal.

9. The method for controlling goods handling equipment to pull goods away from rack according to claim 1, wherein the distance measuring device is fixed on the manipulator, and when the finger needs to pull the bin, the distance measuring device is directly facing the bin.

10. The method for controlling goods handling equipment to pull goods away from rack according to claim 9, wherein the distance measuring device is fixed on an arm of the manipulator and can rotate with the arm and when two rows of racks are provided and placed in parallel, the distance measuring device can aim at any bin in the two rows of racks, and the bin can be pulled by the manipulator.

11. The method for controlling goods handling equipment to pull goods away from rack according to claim 1, wherein in step S1, the manipulator on the bin-pulling machine is rotated from being far away from the bin to be pulled to facing the bin so that the distance measuring device can be conveniently aimed at the bin.

12. The method for controlling goods handling equipment to pull goods away from rack according to claim 11, wherein when the arm of the manipulator rotates at least plus 90 degrees or minus 90 degrees, the manipulator is being far away from the bin.

13. The method for controlling goods handling equipment to pull goods away from rack according to claim 2, wherein when the bin is pulled, the outer end of the bin is lifted upward, the bin is pulled out obliquely, and a bottom of the bin touches the loading platform.

14. The method for controlling goods handling equipment to pull goods away from rack according to claim 3, wherein the distance measuring device is a laser range finder or an ultrasonic range finder, and the laser range finder or ultrasonic range finder is fixed on the manipulator and electrically connected with the controller of the goods handling equipment.

15. The method for controlling goods handling equipment to pull goods away from rack according to claim 3, wherein the distance measuring device is a reset switch, and the reset switch is fixed on the finger of the manipulator; when the finger of the manipulator touches the bin, the reset switch acts; and the reset switch is electrically connected with the controller of the goods handling equipment.

16. The method for controlling goods handling equipment to pull goods away from rack according to claim 3, wherein the distance measuring device is a ranging camera, wherein the ranging camera is fixed on the manipulator and electrically connected with the controller of the goods handling equipment; the controller judges the distance between the finger of the manipulator and the bin according to an image information of the finger of the manipulator and the handle of the bin collected by the ranging camera.

17. The method for controlling goods handling equipment to pull goods away from rack according to claim 2, wherein in step S2, the finger of the manipulator rotates to a horizontal position from bottom to top, and the goods handling equipment controls the bin-pulling machine to move up, so that the handle of the bin is lifted up, making the bin oblique.

18. The method for controlling goods handling equipment to pull goods away from rack according to claim 2, wherein in step S5, when the unhooking state occurs, the controller of the goods handling equipment and/or the bin-pulling machine gives an alarm signal, and the alarm signal comprises an audible and visual alarm signal.

19. The method for controlling goods handling equipment to pull goods away from rack according to claim 2, wherein the distance measuring device is fixed on the manipulator, and when the finger needs to pull the bin, the distance measuring device is directly facing the bin.

20. The method for controlling goods handling equipment to pull goods away from rack according to claim 2, wherein in step S1, the manipulator on the bin-pulling machine is rotated from being far away from the bin to be pulled to facing the bin, so that the distance measuring device can be conveniently aimed at the bin.
